(19) United States
(12) Patent Application Publication
(10) Pub. No.: US 2017/0168611 A1
(43) Pub. Date: Jun. 15, 2017

(54) CAPACITIVE SENSORS

(71) Applicant: Jaejune JANG, Seoul (KR)

(72) Inventor: Jaejune JANG, Seoul (KR)

(21) Appl. No.: 15/374,549

(22) Filed: Dec. 9, 2016

(30) Foreign Application Priority Data
Dec. 15, 2015 (KR) 10-2015-0179416

(51) Int. Cl. G06F 3/044

(52) U.S. Cl. CPC G06F 3/044

(57) ABSTRACT

A capacitive sensor including a substrate, a semiconductor chip on the substrate, at least one bonding wire electrically connecting a top surface of the semiconductor chip to a top surface of the substrate, and a plurality of sensor electrodes on the top surface of the semiconductor chip may be provided. In particular, heights of the sensor electrodes may be provided to be greater than a height of the at least one bonding wire with respect to the top surface of the semiconductor chip.

### CROSS-REFERENCE TO RELATED APPLICATIONS

This U.S. non-provisional patent application claims priority under 35 U.S.C. §119 to Korean Patent Application No. 10-2015-0179416, filed on Dec. 15, 2015, in the Korean Intellectual Property Office, the entire contents of which are hereby incorporated by reference.

### BACKGROUND

Example embodiments of the inventive concepts relate to sensors, and in particular, to capacitive sensors.

A capacitive sensor is a sensing device which is capable of sensing a relatively soft haptic (or manipulation) input, compared with a pressure sensor, based on a capacitive coupling. Thus, the capacitive sensor is widely used to realize user interfaces of portable devices (e.g., mobile phones or tablets). Accordingly, there is an increasing demand for a capacitive sensor, which is capable of detecting a difference in electrostatic capacitance with higher precision.

FIGS. 1A and 1B are sectional views illustrating some conventional capacitive sensors. Referring to FIG. 1A, a capacitive sensor 102 may include a semiconductor chip 120 and one or more sensor electrodes 140 provided on a top surface of the semiconductor chip 120. The sensor electrodes 140 may be opaque or transparent electrodes. The semiconductor chip 120 may be electrically connected to an electric device 110 through one or more bonding wires 125, which are electrically connected to an edge region of the top surface of the semiconductor chip 120. The bonding wires 125 may be electrically connected to, for example, two opposite edges or all edges of the top surface of the semiconductor chip 120. The electric device 110 may be for example, a printed circuit board. The semiconductor chip 120 may be attached to the electric device 110 by an adhesive layer 112. The semiconductor chip 120 may have a thickness T1.

The semiconductor chip 120 may have a recess region 115, which is formed at an edge region thereof, and at which the bonding wire 125 is connected. The recess region 115 may be formed at, for example, opposite two edges or all edges of the semiconductor chip 120. Because the bonding wire 125 is connected to the recess region 115, the bonding wire 125 may have no arch protruding above the semiconductor chip 120. Accordingly, the sensor electrodes 140 may have the allowed minimum height (hereinafter, height H), and thus, may reduce or minimize a total thickness, i.e., T1+H, of the sensor 102. For example, the sensor electrodes 140 may have a circular pillar shape. The sensor 102 may be provided below or under the cover glass 150 having a thickness of T3.

Referring to FIG. 1B, the sensor 102 may further include the mold layer 130 covering a top surface of the semiconductor chip 120. The mold layer 130 may be formed to fill a gap between the cover glass 150 and the semiconductor chip 120 and to fill the recess region 115. The mold layer 130 may be formed to have a thickness capable of entirely covering the sensor electrodes 140.

The foregoing conventional capacitive sensors suffer from challenges of forming the recessed region 115 at an edge or edges of the semiconductor chip 120 and experiences relatively big parasitic electrostatic capacitance between the semiconductor chip 120 and the sensor electrodes 140.

Accordingly, capacitive sensors which are capable of minimizing or reducing a parasitic electrostatic capacitance between a semiconductor chip and sensor electrodes, while providing a sufficient clearance margin for a bonding wire are actively researched.

### SUMMARY

Some example embodiments of the inventive concepts provide a capacitive sensor configured to have an increased electrostatic capacitance.

Some example embodiments of the inventive concepts provide a capacitive sensor configured to have a reduced parasitic electrostatic capacitance.

In a capacitive sensor according to some example embodiments of the inventive concepts, a head of an electrode of the sensor may have an increased area.

In a capacitive sensor according to some example embodiments of the inventive concept, the sensor electrode may have a high aspect ratio, and thus, reduce or minimize a parasitic electrostatic capacitance between a head of the sensor electrode and a semiconductor chip.

According to an example embodiment, a capacitive sensor includes a substrate, a semiconductor chip on the substrate, at least one bonding wire electrically connecting a top surface of the semiconductor chip to a top surface of the substrate, and a plurality of sensor electrodes on the top surface of the semiconductor chip. Heights of the sensor electrodes may be greater than a height of the at least one bonding wire with respect to the top surface of the semiconductor chip.

In some example embodiments, the capacitive sensor may further include a mold layer filling spaces between the sensor electrodes.

In some example embodiments, a height of the mold layer on the top surface of the semiconductor chip may be higher than the height of the at least one bonding wire with respect to the top surface of the semiconductor chip.

In some example embodiments, the height of the mold layer on the top surface of the semiconductor chip may be greater than the heights of the sensor electrodes.

In some example embodiments, each of the sensor electrodes may have a T-shaped vertical cross section, which includes a body portion extending in a vertical direction from the top surface of the semiconductor chip and a head portion extending in a direction parallel to the top surface of the semiconductor chip at a top surface of the body portion. A horizontal cross sectional area of the head portion may be substantially greater than a horizontal cross sectional area of the body portion.

In some example embodiments, the body portion may have a pillar-shaped structure and the head portion may have a plate-shaped structure.

In some example embodiments, the horizontal cross sectional area of the body portion may have one of a circular shape and a polygonal shape.

In some example embodiments, the horizontal cross sectional area of the head portion may have one of a polygonal plate shape, which is bounded by a finite chain of three or more straight line segments, and a disk shape.

In some example embodiments, the body portion may have a cylinder structure having a first diameter, the horizontal cross sectional area of the head portion may have a tetragonal plate shape, and a length of one of the straight line segments of the tetragonal plate shape may be substantially equal to or smaller than the heights of the sensor electrodes and be greater the first diameter.

In some example embodiments, the body portion may have a cylinder structure having a first diameter, the head portion may have a disk shape having a second diameter, and the second diameter may be greater than the first diameter and be substantially equal to or smaller than the heights of the sensor electrodes.

In some example embodiments, each of the sensor electrodes may include a body portion extending in a vertical direction from the top surface of the semiconductor chip, and a head portion extending in a direction parallel to the top surface of the semiconductor chip at a top surface of the body portion and having a hemispherical structure.

In some example embodiments, the head portion may have an upper hemisphere shape, and a diameter of the horizontal cross sectional area of the head portion may gradually decrease or increase in a direction away from the body portion.

In some example embodiments, the sensor electrodes may be provided in a grid, and the heights of the sensor electrodes may be substantially equal to a pitch between the sensor electrodes.

In some example embodiments, the capacitive sensor may further include at least one bonding pad at an edge of the top surface of the semiconductor chip and outside an area including the sensor electrodes. The at least one bonding wire may be in contact with the semiconductor chip via the at least one bonding pad.

In some example embodiments, the capacitive sensor may further include a plurality of bonding pads on the semiconductor chip and connected to the sensor electrodes, each of the sensor electrodes including a body portion extending in a vertical direction from the top surface of the semiconductor chip and a head portion extending in a direction parallel to the top surface of the semiconductor chip at a top surface of the body portion and having a maximum planar area wider than a planar area of the body portion, An area of each of the bonding pad may be comparable to or slightly greater than a planar area of the body portion and substantially smaller than the maximum planar area of the head portion.

According to an example embodiment, a capacitive sensor includes a substrate, a semiconductor chip on the substrate, at least one bonding wire electrically connecting the semiconductor chip to the substrate, a plurality of sensor electrodes on a top surface of the semiconductor chip, and a mold layer filling a space between the sensor electrodes. At least one of heights of the sensor electrodes and a height of the mold layer may be greater than a height of the at least one bonding wire with respect to the top surface of the semiconductor chip by a margin.

In some example embodiments, the height of the mold layer may be substantially equal to the heights of the sensor electrodes such that a top surface of the mold layer is substantially coplanar with top surfaces of the sensor electrodes.

In some example embodiments, the height of the mold layer may be greater than the heights of the sensor electrodes such that a top surface of the mold layer is at a higher level than top surfaces of the sensor electrodes.

In some example embodiments, each of the sensor electrodes have a T-shaped vertical cross section, which includes a body portion extending in a vertical direction from the top surface of the semiconductor chip, and a head portion extending in a direction parallel to the top surface of the semiconductor chip at a top surface of the body portion. A maximum horizontal cross sectional area of the head portion may be substantially greater than a horizontal cross sectional area of the body portion.

In some example embodiments, a top surface of the head portion included in each of the sensor electrodes may be substantially coplanar with a top surface of the mold layer.

In some example embodiments, the head portions included in the sensor electrodes may be arranged to form a grid with a set pitch, and the set pitch may be substantially equal to the heights of the sensor electrodes.

According to an example embodiment, a capacitive sensor includes a substrate, a semiconductor chip on the substrate, at least one bonding wire electrically connecting a top surface of the semiconductor chip to a top surface of the substrate, a plurality of sensor electrodes on the top surface of the semiconductor chip, and a mold layer filling spaces between the sensor electrodes, at least one of heights of the sensor electrodes and a height of the mold layer being greater than a height of the bonding wire with respect to the top surface of the semiconductor chip. Each of the sensor electrodes may have a T-shaped vertical cross section, which includes a body portion extending in a vertical direction from the top surface of the semiconductor chip, and a head portion extending in a direction parallel to the top surface of the semiconductor chip at a top surface of the body portion. A maximum horizontal cross sectional area of the head portion may be substantially greater than a horizontal cross sectional area of the body portion.

In some example embodiments, the heights of the sensor electrodes may be substantially equal to or less than the height of the mold layer.

In some example embodiments, a longitudinal and traverse length of the maximum horizontal cross sectional area of the head portion may be substantially equal to or less than the heights of the sensor electrodes.

In some example embodiments, the body portion may have a horizontal cross sectional area selected from the group consisting of a circular shape and a polygon shape, and the head portion may have a shape selected from the group consisting of a polygonal plate shape, a disk shape, an upper hemisphere shape, and a lower hemisphere shape.

In some example embodiments, the capacitive sensor of claim may further include a plurality of bonding pads on the semiconductor chip and connected to the sensor electrodes. An area of each of the bonding pad may be comparable to or slightly greater than the horizontal cross sectional area of the body portion and substantially smaller than the maximum horizontal cross sectional area of the head portion.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1A is a sectional view illustrating a conventional capacitive sensor.

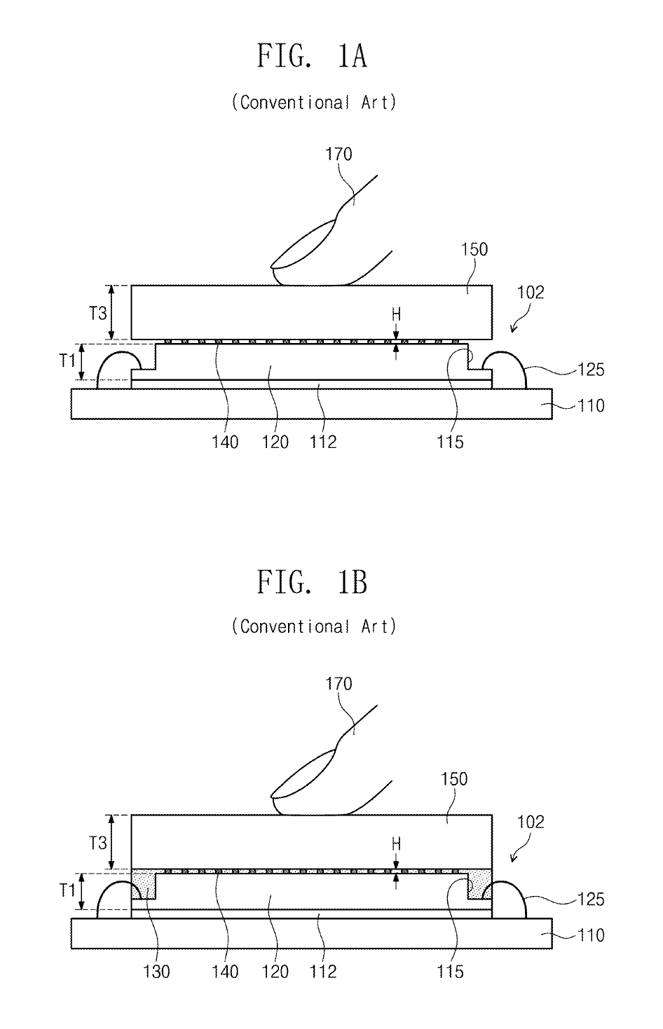

FIG. 1B is a sectional view illustrating another conventional capacitive sensor.

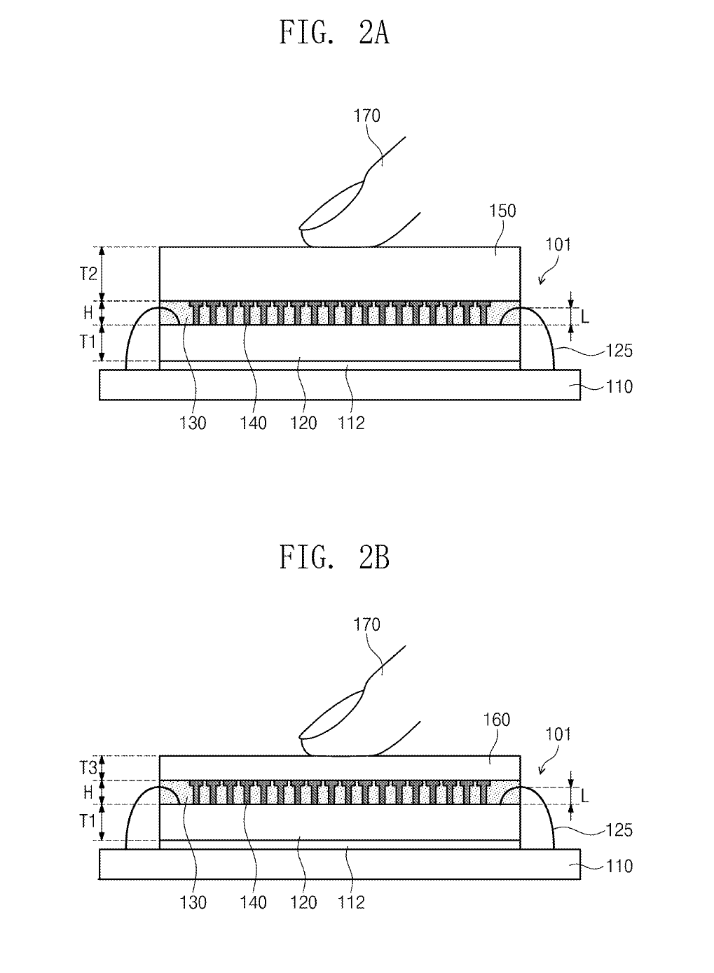

FIG. 2A is a sectional view illustrating a capacitive sensor according to an example embodiment of the inventive concepts.

FIG. 2B is a sectional view illustrating a capacitive sensor according to an example embodiment of the inventive concepts.

FIG. 2C is a sectional view illustrating a capacitive sensor according to an example embodiment of the inventive concepts.

FIG. 2D is a sectional view illustrating a capacitive sensor according to an example embodiment of the inventive concepts.

FIG. 3A is a perspective view illustrating an electrode of a capacitive sensor according to an example embodiment of the inventive concepts.

FIG. 3B is a plan view illustrating an electrode array of a capacitive sensor according to an example embodiment of the inventive concepts.

FIG. 3C is a perspective view schematically illustrating a sensing operation of a capacitive sensor according to an example embodiment of the inventive concepts.

FIG. 4A is a perspective view illustrating an electrode of a capacitive sensor according to an example embodiment of the inventive concepts.

FIG. 4B is a plan view illustrating an electrode array of a capacitive sensor according to an example embodiment of the inventive concepts.

FIG. 4C is a perspective view illustrating an electrode of a capacitive sensor according to an example embodiment of the inventive concepts.

FIG. 4D is a perspective view illustrating an electrode of a capacitive sensor according to an example embodiment of the inventive concepts.

FIGS. 5A through 5C are sectional views illustrating a method of forming an electrode of a capacitive sensor according to an example embodiment of the inventive concepts.

FIGS. 6A through 6C are sectional views illustrating a method of forming an electrode of a capacitive sensor according to an example embodiment of the inventive concepts.

FIGS. 7A through 7C are sectional views illustrating a method of forming a sensor electrode of a capacitive sensor according to an example embodiment of the inventive concepts.

FIG. 8 is a perspective view illustrating a cellular phone including at least one capacitive sensor according to an example embodiment of the inventive concepts.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given example embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Various example embodiments of the inventive concepts will now be described more fully with reference to the accompanying drawings, in which some example embodiments are shown. Example embodiments of the inventive concepts may, however, be embodied in many different forms and should not be construed as being limited to the example embodiments set forth herein; rather, these embodiments are provided so that this disclosure will be thorough and complete, and will fully convey the concepts of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Some example embodiments of the inventive concepts are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing.

As used herein, the term “and/or” includes any and all combinations of one or more of the associated listed items. Expressions such as “at least one of,” when preceding a list of elements, modify the entire list of elements and do not modify the individual elements of the list

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, some example embodiments will be explained in further detail with reference to the accompanying drawings.

### Examples of Capacitive Sensor

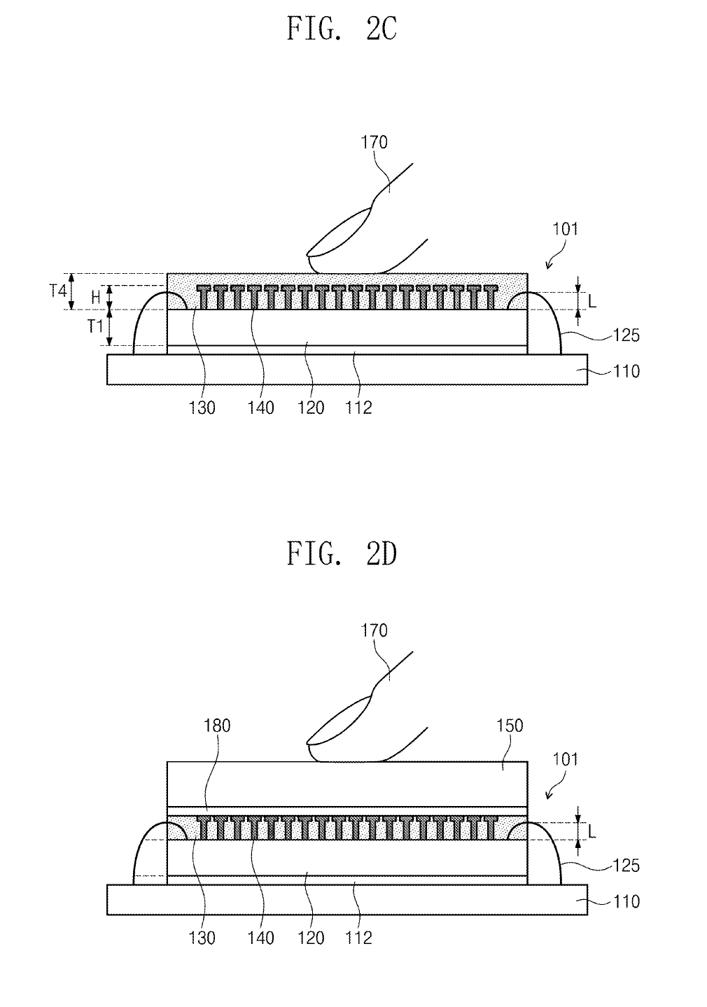

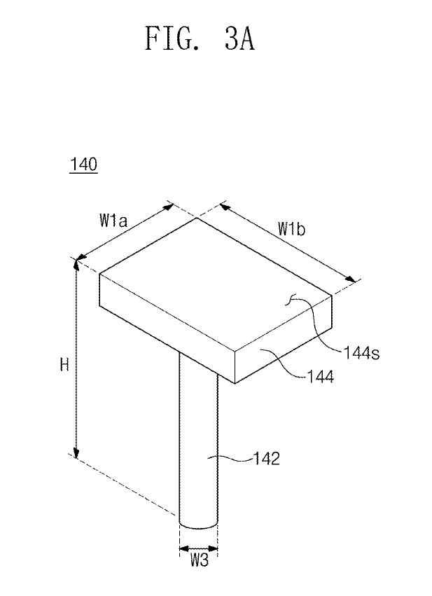

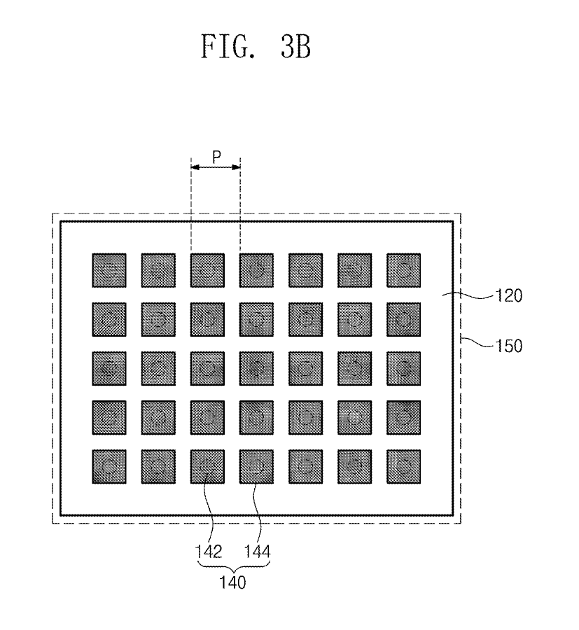

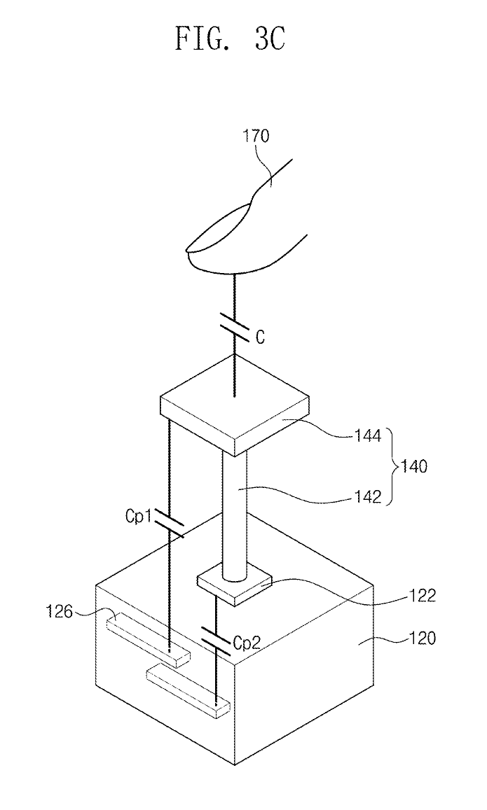

FIGS. 2A through 2D are sectional views illustrating capacitive sensors, according to an example embodiment of the inventive concepts.

Referring to FIG. 2A, a capacitive sensor 101 may include a semiconductor chip 120 and one or more sensor electrodes 140 provided on a top surface of the semiconductor chip 120. The sensor electrode 140 may be a transparent electrode, which may be formed of or include indium tin oxide (ITO), zinc oxide (ZnO), indium zinc oxide (IZO), cadmium tin oxide (CTO), grapheme, carbon nanotube (CNT), and so forth. Alternatively, the electrode 140 may be an opaque electrode, which may be formed of or include a metal (e.g., copper (Cu), silver (Ag), and aluminum (Al)). The semiconductor chip 120 may be electrically connected to an electric device 110 through one or more bonding wires 125, which are electrically connected to an edge region of the top surface of the semiconductor chip 120. The bonding wires 125 may be electrically connected to two opposite edges or all edges of the top surface of the semiconductor chip 120. The electric device 110 may be, for example, a printed circuit board. The semiconductor chip 120 may be physically attached to the electric device 110 by an adhesive layer 112. The semiconductor chip 120 may have a thickness T1 ranging, for example, from about 100 μm to about 300 μm. The top surface of the semiconductor chip 120 may be flat.

The sensor 101 may be provided below or under a cover glass 150, to which a finger 170 of a user will be touched. The cover glass 150 may include, for example, sapphire. The cover glass 150 may have a thickness T2 ranging, for example, from about 200 μm to about 300 μm. The sensor 101 may be in contact with a bottom surface of the cover glass 150. For example, the sensor electrodes 140 may be in direct contact with the bottom surface of the cover glass 150. An insulating mold layer 130 may be provided to fill a space between the cover glass 150 and the semiconductor chip 120. The mold layer 130 may be formed of or include an epoxy molding compound or an epoxy-based non-conductive paste. In some example embodiments, the mold layer 130 may be formed of or include an inorganic insulating layer (e.g., an oxide or nitride layer). The mold layer 130 may allow the sensor electrodes 140 to have improved structural stability and may suppress or prevent contaminants from being infiltrated into the space between the cover glass 150 and the semiconductor chip 120. For example, the mold layer 130 may have a thickness that is substantially equivalent to a height H of the sensor electrode 140. Accordingly, the mold layer 130 may be in direct contact with the bottom surface of the cover glass 150. Further, the top surface of the mold layer 130 may be coplanar with a top surface of the sensor electrode 140.

As another example, as shown in FIG. 2B, the sensor 101 may be provided below or under a protection film 160. The protection film 160 may have a thickness T3 ranging, for example, from about 40 μm to about 60 μm. The protection film 160 may be formed of or include an insulating polymeric material (e.g., Fluorinated Ethylene Propylene (FEP) or polyimide). The user's finger 170 may contact a top surface of the protection film 160.

As still another example, as shown in FIG. 2C, the mold layer 130 may be provided to entirely cover the sensor electrodes 140 and have a thickness T4, which is greater than the height H of the sensor electrode 140. The user's finger 170 may contact a top surface of the mold layer 130. As shown in FIG. 2D, the sensor 101 may further include a cosmetic layer 180. The cosmetic layer 180 may be provided between the cover glass 150 and the semiconductor chip 120 and may cover the mold layer 130. The cosmetic layer 180 may include an opaque or transparent ink layer.

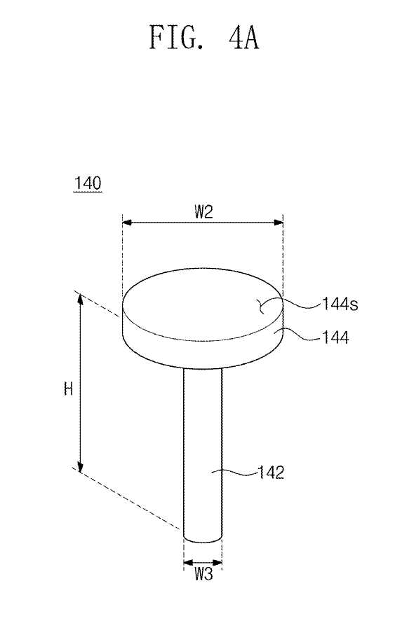

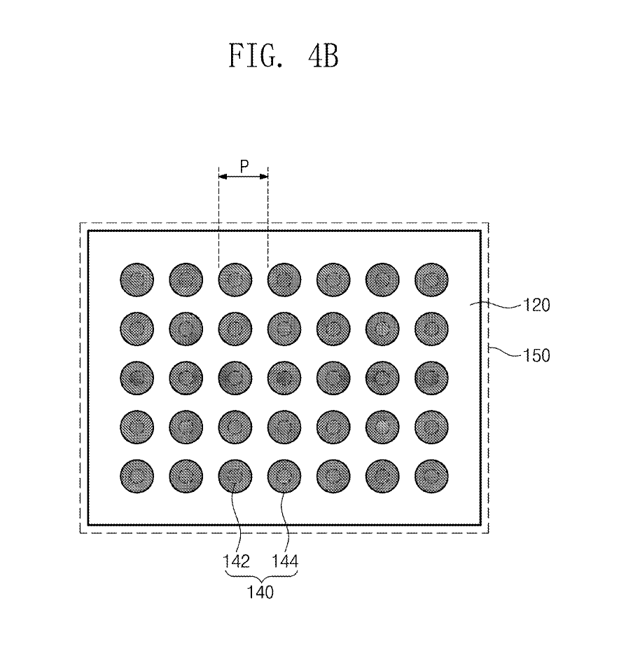

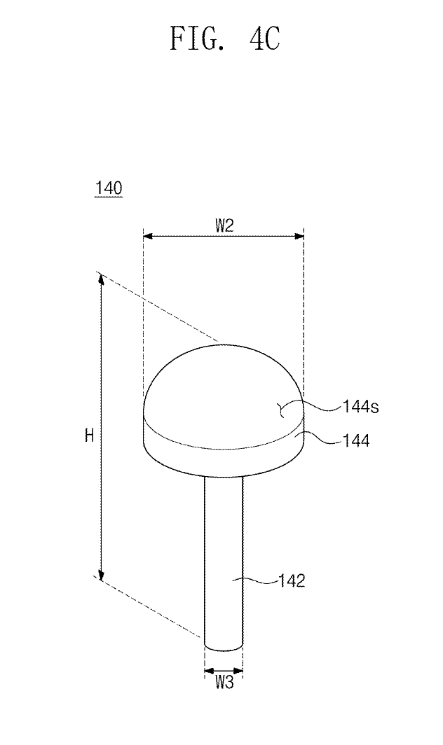

Referring back to FIG. 2A, the sensor electrodes 140 may include bumps of high aspect ratio, as will be described with reference to FIG. 3A. The height H of the sensor electrode 140 may be substantially equivalent to a distance from the top surface of the semiconductor chip 120 to the bottom surface of the cover glass 150. The bonding wire 125 may have an arch-shaped portion, which has a height L with respect to the top surface of the semiconductor chip 120. The height H of the sensor electrode 140 may be greater than the height L of the bonding wire 125. As an example, the height H of the sensor electrode 140 may be about 50 μm or greater. However, example embodiments of the inventive concepts are not limited thereto.

The sensor 101 may include, for example, a touch sensor or a finger scan sensor. For example, when the finger 170 contacts the cover glass 150, there may be differences in distance from the sensor electrodes 140 between patterns (e.g., valleys and ridges), which constitute the fingerprint of the finger 170. The sensor 101 may be a finger scan sensor or a fingerprint recognition sensor that is configured to obtain information on spatial variation of electrostatic capacitance caused by such differences in distance. As will be described below, the sensor electrodes 140 may be provided to have a shape and an array structure that is suitable for sensing the fingerprint of the finger 170.

### Examples of Sensor Electrode

FIG. 3A is a perspective view illustrating a sensor electrode of a capacitive sensor according to an example embodiment of the inventive concepts. FIG. 3B is a plan view illustrating a sensor electrode array of a capacitive sensor according to an example embodiment of the inventive concepts. FIG. 3C is a perspective view schematically illustrating a sensing operation of a capacitive sensor according to an example embodiment of the inventive concepts.

Referring to FIGS. 2A and 3A, the sensor electrode 140 may include a body 142 and a head 144. The body 142 may extend vertically from the top surface of the semiconductor chip 120 and the head 144 may extend parallel to the top surface of the semiconductor chip 120 at a top end of the body 142. The head 144 may have a planar area greater than that of the body 142. Thus, the sensor electrode 140 may have a ‘T’-shaped section. The body 142 may be electrically connected to the semiconductor chip 120, and the head 144 may be in contact with, for example, the cover glass 150. To improve a sensing capability of the sensor electrode 140, it is desirable to provide the head 144 to have relatively wide planar area, while providing the body 142 to have a smaller planar area (e.g., horizontal cross section) than the head 144.

As shown in FIG. 3A, the head 144 may have a plate-shaped structure and the body 142 may have a pillar-shaped structure (e.g., a circular pillar or a square pillar). For example, the head 144 may be shaped like a rectangular plate, whose longitudinal and traverse lengths W1a and W1b are equal to or different from each other. The head 144 may have a flat surface 144s. The head 144 and the body 142 may be formed of or include the same conductive material. As another example, the head 144 and the body 142 may be formed of or include different conductive materials.

The longitudinal and traverse lengths W1a and W1b of the head 144 may be smaller than the height H of the sensor electrode 140. Alternatively, the longitudinal and traverse lengths W1a and W1b of the head 144 may be equal to or greater than the height H of the sensor electrode 140. The body 142 may be provided in the form of a circular pillar, whose diameter W3 is smaller than the longitudinal and traverse lengths W1a and W1b of the head 144.

As an example, in the case where the head 144 has a square shape, each of the longitudinal and traverse lengths W1a and W1b may be about 50 μm or less. As another example, in the case where the head 144 has a rectangular shape, one of the longitudinal and traverse lengths W1a and W1b may be about 50 μm and the other may be less than 50 μm. The diameter W3 of the body 142 may range from about 5 μm to about 40 μm. The aspect ratio of the sensor electrode 140 may be defined as a value obtained by dividing the height H of the sensor electrode 140 with the diameter W3 of the body 132 (i.e., H/W3).

As an example, the sensor electrode 140 may be provided to have an aspect ratio of 1 or higher, but example embodiments of the inventive concepts are not limited thereto. For example, the height H of the sensor electrode 140 may be about 50 μm or greater, the head 144 may be a tetragonal or rectangular plate, whose longitudinal and traverse lengths (i.e., W1a and W1b) are about 50 μm, and the body 142 may be a circular pillar, whose diameter (i.e., W3) is about 40 μm or less. For example, the height H of the electrode 140 may range from about 50 μm to about 150 μm, and the diameter W3 of the body 142 may range from about 15 μm to about 40 μm.

As shown in FIG. 3B, the sensor electrodes 140 may be regularly arranged on the semiconductor chip 120, thereby forming a grid structure. The sensor electrodes 140 may be arranged to have a resolution of, for example, 500 dpi or higher. The heads 144 may be disposed to have a pitch P that is equal or similar to the height H of the sensor electrode 140. For example, the pitch P may be about 50 μm. As another example, the heads 144 may be disposed to have a pitch P that is different from the height H of the sensor electrode 140. For example, the pitch P may be smaller or greater than 50 μm.

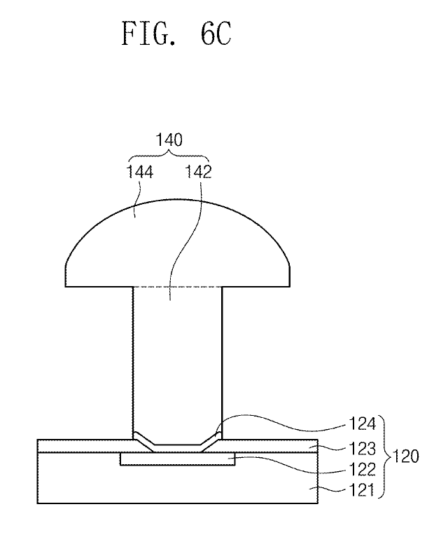

Referring to FIG. 3C, the body 142 of the sensor electrode 140 may be electrically connected to the semiconductor chip 120. For example, the semiconductor chip 120 may include a bonding pad 122 connected to the body 142 of the sensor electrode 140. A metal layer 124 (e.g., of FIG. 5C) may be further provided between the bonding pad 122 and the body 142. A conductive structure (e.g., a plurality of metal lines 126) may be provided in the semiconductor chip 120.

An electrostatic capacitance C may be provided between the finger 170 and the head 144 when the finger 170 contacts, for example, the cover glass 150 as illustrated in FIG. 2A. A parasitic electrostatic capacitance Cp1 may be further provided between the metal lines 126 of the semiconductor chip 120 and the head 144 of the sensor electrode 140. In some example embodiments, as previously described with reference to FIG. 3A, the sensor electrode 140 may have a high aspect ratio, and this may lead to an increase in distance between the head 144 and the metal lines 126. Accordingly, the parasitic electrostatic capacitance Cp1 between the head 144 of the sensor electrode 140 and the metal lines 126 may be decreased.

The bonding pad 122 may be provided to have relatively narrow or small planar area. For example, a dimension of the bonding pad 122 may be less than the dimensions W1a×W1b of the head 144 shown in FIG. 3A and may be equal to or greater than the planar area of the body 142. As an example, the bonding pad 122 may have an area of about 15 μm×15 μm. Because the bonding pad 122 has a relatively small planar area, a parasitic electrostatic capacitance Cp2 between the bonding pad 122 and the metal lines 126 may be reduced or minimized.

That is, the sensor electrode 140 may have a high aspect ratio, and the bonding pad 122 may have minimized relatively small planar area. Accordingly, the parasitic electrostatic capacitances Cp1 and Cp2 can be minimized, thereby allowing more precise sensing of the electrostatic capacitance C between the finger 170 and the head 144.

### Other Examples of Sensor Electrode

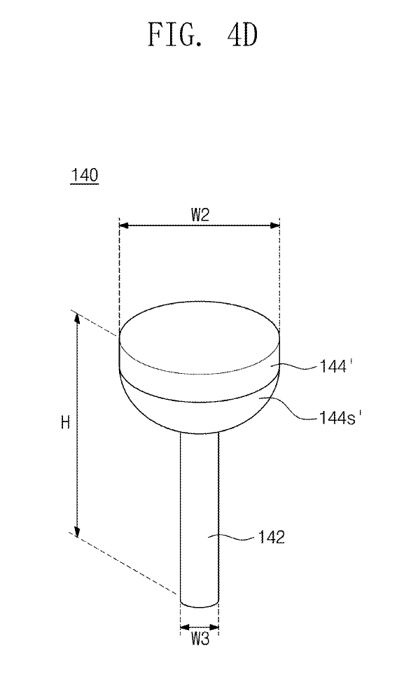

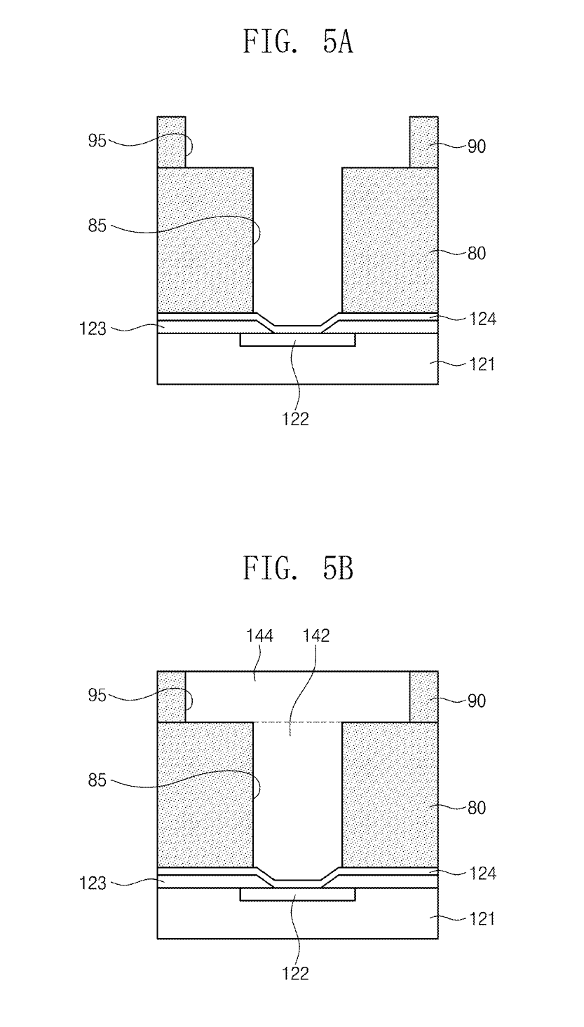

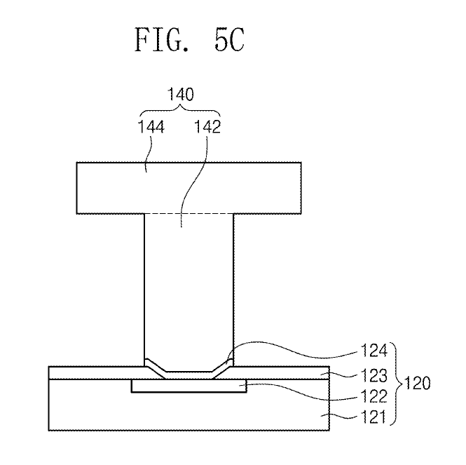

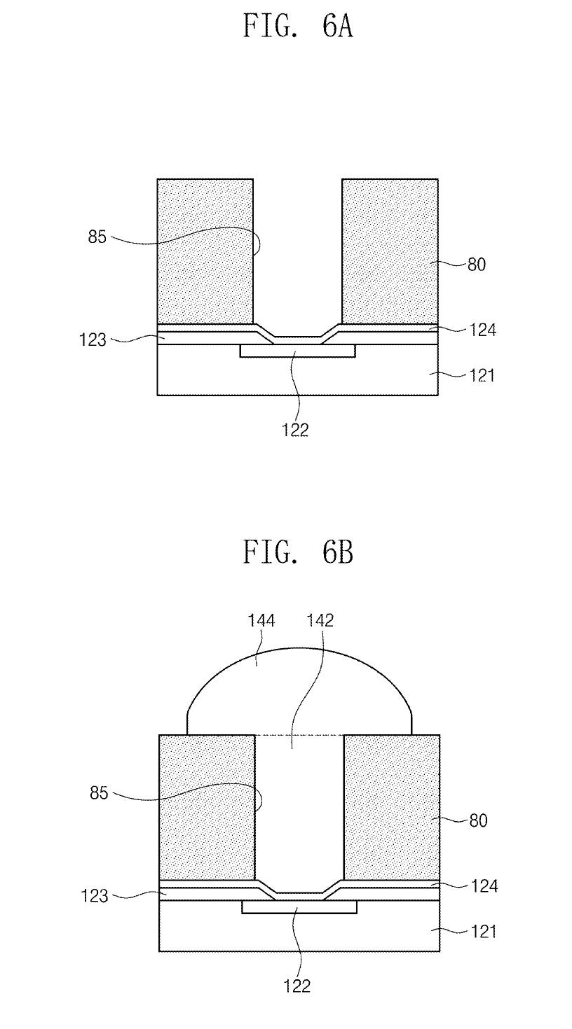

FIG. 4A is a perspective view illustrating a sensor electrode of a capacitive sensor according to an example embodiment of the inventive concepts. FIG. 4B is a plan view illustrating a sensor electrode array of a capacitive sensor according to an example embodiment of the inventive concepts. FIG. 4C is a perspective view illustrating a sensor electrode of a capacitive sensor according to an example embodiment of the inventive concepts. FIG. 4D is a perspective view illustrating a sensor electrode of a capacitive sensor according to an example embodiment of the inventive concepts.

Referring to FIG. 4A, the sensor electrode 140 may include the head 144 having a disk shape and the body 142 having a pillar shape. Thus, a vertical section of the sensor electrode 140 may have a letter ‘T’ shape. For example, the head 144 may have a diameter W2, which is greater than the diameter W3 of the body 142 and less than the height H of the sensor electrode 140. As another example, the diameter W2 of the head 144 may be equal to or greater than the height H of the sensor electrode 140. The head 144 may have a flat surface 144s.

Referring to FIG. 4B, the sensor electrodes 140 may be arranged on the semiconductor chip 120 to form a grid-shaped arrangement, whose resolution is 500 dpi or higher. The heads 144 may be arranged to have a pitch P of, for example, 50 μm or higher or of 50 μm or less.

Referring to FIG. 4C, the sensor electrode 140 may have a mushroom-shaped section. For example, the body 142 of the sensor electrode 140 may have a circular pillar shape and the head 144 of the sensor electrode 140 may have an upper hemisphere shape. The head 144 may have a maximum diameter W2, which is greater than the diameter W3 of the body 142. However, a diameter of planar area (e.g., horizontal cross section) of the head 144 gradually decreases in a direction away from the body 142. The head 144 may have a curved surface 144s protruding in the direction away from the body 142.

Referring to FIG. 4D, the sensor electrode 140 may have a mushroom-shaped section. For example, the body 142 of the sensor electrode 140 may have a circular pillar shape and the head 144′ of the sensor electrode 140 may have a lower hemisphere shape. The head 144′ may have a maximum diameter W2, which is greater than the diameter W3 of the body 142. The head 144′ may have a curved surface 144s′ protruding in the direction close to the body 142. However, a diameter of planar area (e.g., horizontal cross section) of the head 144′ gradually increases in a direction away from the body 142. Because the lower portion of the lower hemisphere shaped head has a smaller planar area, parasitic electrostatic capacitance between the head and the semiconductor chip according to the sensor electrode structure of FIG. 4D may be further reduced compared to the sensor electrode structure of FIG. 4C.

### Example Method of Forming Sensor Electrode

FIGS. 5A through 5C are sectional views illustrating a method of forming a sensor electrode of a capacitive sensor according to an example embodiment of the inventive concepts.

Referring to FIG. 5A, a protection layer 123 may be formed on a semiconductor substrate 121 with the bonding pad 122. The protection layer 123 may have a pattern to expose the bonding pad 122. In some example embodiments, a metal layer 124 may be formed on the protection layer 123 and may be coupled to the bonding pad 122. The metal layer 124 may be formed to have a single- or multi-layered structure. A first mask layer 80 with a first opening 85 may be formed on the semiconductor substrate 121 and/or the metal layer 124 by coating and pattering, for example, a photoresist layer, an oxide layer, and/or a nitride layer. Then, a second mask layer 90 with a second opening 95 may be formed on the first mask layer 80. The second opening 95 may be aligned to the first opening 85 and may have a width greater than that of the first opening 85. For example, the first opening 85 may be formed to have a circular cylindrical shape, and the second opening 95 may be formed to have a rectangular or circular cylindrical shape.

Referring to FIG. 5B, a first conductive layer 142 and a second conductive layer 144 may be formed, by a deposition or plating process, to fill the first opening 85 and the second opening 95, respectively. As an example, the first conductive layer 142 may be formed of the same conductive material as the second conductive layer 144. As another example, the first conductive layer 142 may be formed of a first conductive material, and the second conductive layer 144 may be formed of a second conductive material that is different from the first conductive material.

Referring to FIG. 5C, the first mask layer 80 and the second mask layer 90 may be removed, and a portion of the metal layer 124 may be removed. Accordingly, the sensor electrode 140 of FIG. 3A or FIG. 4A, which is electrically connected to the bonding pad 122, may be formed on the semiconductor chip 120, which is provided with the bonding pad 122. The sensor electrode 140 may include the first conductive layer 142 (e.g., the body), which is connected to the bonding pad 122, and the second conductive layer 144 (e.g., the head), which is larger than the body 142. Shapes of the body 142 and the head 144 may be changed depending on shapes of the first opening 85 and the second opening 95 of FIG. 5A, respectively.

### Another Example Method of Forming Sensor Electrode

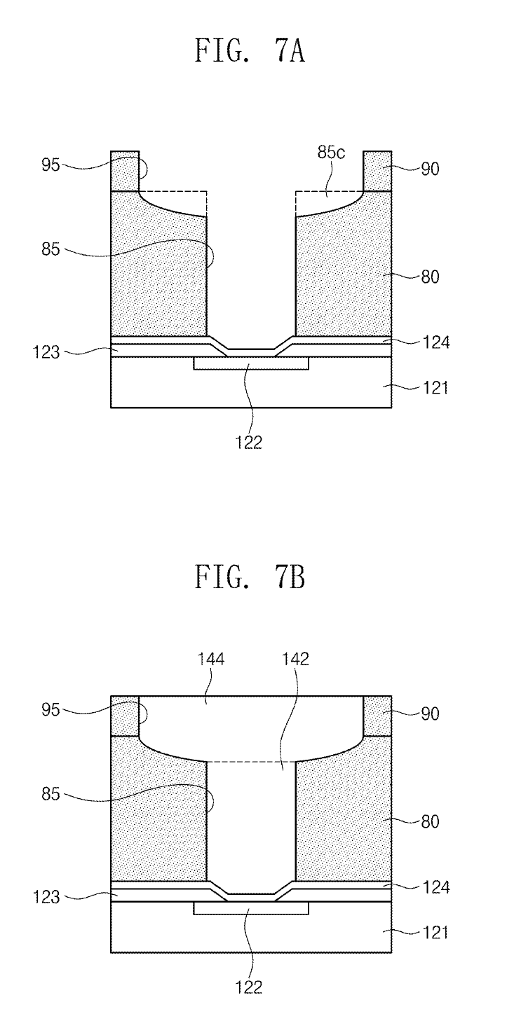

FIGS. 6A through 6C are sectional views illustrating a method of forming a sensor electrode of a capacitive sensor according to an example embodiment of the inventive concepts.

Referring to FIG. 6A, the first mask layer 80 with the first opening 85 may be formed on the semiconductor substrate 121 by the same or similar process as that described with reference to FIG. 5A. For example, the first opening 85 may have a circular cylindrical shape.

Referring to FIG. 6B, the first conductive layer 142 and the second conductive layer 144 may be formed by, for example, a plating process. The first conductive layer 142 may be formed to fill the first opening 85 and the second conductive layer 144 may be formed on the top surface of the first mask layer 80. As another example, the first conductive layer 142 may be formed by a plating or deposition process, and the second conductive layer 144 may be formed by a plating process. The first conductive layer 142 and the second conductive layer 144 may be formed of the same conductive material or different conductive materials. As an example, the first conductive layer 142 may be formed to have a circular cylindrical shape, and the second conductive layer 144 may be formed to have a hemispherical shape (e.g., an upper hemisphere shape).

Referring to FIG. 6C, the first mask layer 80 may be removed, and a portion of the metal layer 124 may be removed. Accordingly, the sensor electrode 140 of FIG. 4C, which is electrically connected to the bonding pad 122, may be formed on the semiconductor chip 120, which is provided with the bonding pad 122.

### Still Another Example Method of Forming Sensor Electrode

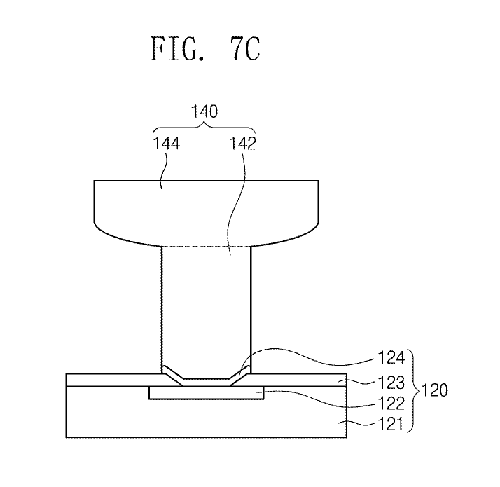

FIGS. 7A to 7C are sectional views illustrating a method of forming a sensor electrode of a capacitive sensor according to an example embodiment of the inventive concept.

Referring to FIG. 7A, the first mask layer 80 with the first opening 85 and the second mask layer 90 with the second opening 95 may be formed on the semiconductor substrate 121 by the same or similar process as the process described with reference to FIG. 5A. In some example embodiments, a top corner 85c of the first opening 85 may be further removed, and thus, the first opening 85 may be formed to have a cup-shaped section. In other example embodiments, the first opening 85 with a cup-shaped section may be formed by further removing a portion of the first mask layer 80 while the second mask layer 90 is patterned to form the second opening 95.

Referring to FIG. 7B, a deposition or plating process may be performed to form the first conductive layer 142 filling the first opening 85 and the second conductive layer 144 filling the second opening 95. The first conductive layer 142 and the second conductive layer 144 may be formed of the same conductive material or different conductive materials. In some example embodiments, the first conductive layer 142 may be formed to have a circular pillar shape and the second conductive layer 144 may be formed to have a hemispherical shape as illustrated in FIG. 4D (e.g., a shape corresponding to a bottom half of a sphere).

Referring to FIG. 7C, the first mask layer 80 may be removed and the metal layer 124 may be partially removed. Accordingly, the electrode 140 may be formed on the semiconductor chip 120, which includes the semiconductor substrate 121 provided with the bonding pad 122. Thus, the electrode 140 may have the structure as described with reference to FIG. 4D and may be electrically connected to the bonding pad 122.

### Application

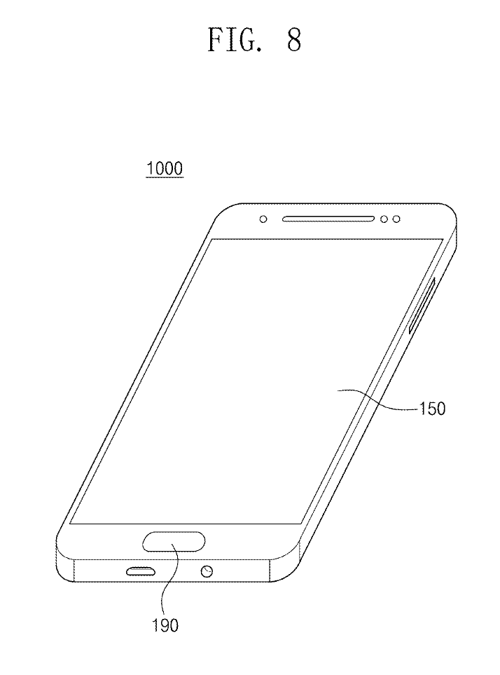

FIG. 8 is a perspective view illustrating a cellular phone including at least one of capacitive sensors according to an example embodiment of the inventive concepts.

Referring to FIG. 8, the sensors 101 disclosed in the present specification may be used as a part of a cellular phone 1000. For example, the cellular phone 1000 may include the cover glass 150 (optionally, including a home button 190) provided on a front side thereof, and at least one of the sensors 101 may be disposed below at least one of the cover glass 150. At least one of the sensors 101 may be a finger scan sensor or a touch sensor, in the cellular phone 1000. As another example, the sensor 101 may be used as a part of an electronic device (e.g., a tablet computer, a desktop computer, a game console, an MP3 player, and so forth), in which a display or a button configured to sense a touch of a user.

According to example embodiments of the inventive concepts, a sensor electrode may be provided to have a large head, which enables an increase in electrostatic capacitance of the sensor electrode. Furthermore, the sensor electrode may be provided to have a high aspect ratio, which enables a reduction of parasitic electrostatic capacitance between the head and the semiconductor chip. Accordingly, a sensing ability of the sensor electrode, to realize a more precise detection of a touch event or a fingerprint, may be improved, thereby improving reliability of the capacitive sensor.

While some example embodiments of the inventive concepts have been particularly shown and described, it will be understood by one of ordinary skill in the art that variations in form and detail may be made therein without departing from the spirit and scope of the attached claims.

1. A capacitive sensor, comprising:
a substrate;
a semiconductor chip on the substrate;
at least one bonding wire electrically connecting a top surface of the semiconductor chip to a top surface of the substrate; and
a plurality of sensor electrodes on the top surface of the semiconductor chip, heights of the sensor electrodes being greater than a height of the at least one bonding wire with respect to the top surface of the semiconductor chip.

2. The capacitive sensor of claim 1, further including:
a mold layer filling spaces between the sensor electrodes.

3. The capacitive sensor of claim 2, wherein a height of the mold layer on the top surface of the semiconductor chip is higher than the height of the at least one bonding wire with respect to the top surface of the semiconductor chip.

4. The capacitive sensor of claim 3, wherein the height of the mold layer on the top surface of the semiconductor chip is greater than the heights of the sensor electrodes.

5. The capacitive sensor of claim 1, wherein each of the sensor electrodes has a T-shaped vertical cross section, which includes,
a body portion extending in a vertical direction from the top surface of the semiconductor chip, and
a head portion extending in a direction parallel to the top surface of the semiconductor chip at a top surface of the body portion, a horizontal cross sectional area of the head portion being substantially greater than a horizontal cross sectional area of the body portion.

6. The capacitive sensor of claim 5, wherein the body portion has a pillar-shaped structure and the head portion has a plate-shaped structure.

7. The capacitive sensor of claim 5, wherein the horizontal cross sectional area of the body portion has one of a circular shape and a polygonal shape.

8. The capacitive sensor of claim 5, wherein the horizontal cross sectional area of the head portion has one of a polygonal plate shape, which is bounded by a finite chain of three or more straight line segments, and a disk shape.

9. The capacitive sensor of claim 5, wherein the body portion has a cylinder structure having a first diameter, the horizontal cross sectional area of the head portion has a tetragonal plate shape, and a length of one of straight line segments of the tetragonal plate shape is substantially equal to or smaller than the heights of the sensor electrodes and is greater the first diameter.

10. The capacitive sensor of claim 6, wherein the body portion has a cylinder structure having a first diameter, the head portion has a disk shape having a second diameter, and the second diameter is greater than the first diameter and is substantially equal to or smaller than the heights of the sensor electrodes.

11. The capacitive sensor of claim 1, wherein each of the sensor electrodes includes,
a body portion extending in a vertical direction from the top surface of the semiconductor chip, and
a head portion extending in a direction parallel to the top surface of the semiconductor chip at a top surface of the body portion and having a hemispherical structure.

12. The capacitive sensor of claim 5, wherein the head portion has an upper hemisphere shape, and a diameter of the horizontal cross sectional area of the head portion gradually decreases or increases in a direction away from the body portion.

13. The capacitive sensor of claim 1, wherein the sensor electrodes are provided in a grid, and the heights of the sensor electrodes are substantially equal to a pitch between the sensor electrodes.

14. The capacitive sensor of claim 1, further comprising:
at least one bonding pad at an edge of the top surface of the semiconductor chip and outside an area including the sensor electrodes, wherein the at least one bonding wire is in contact with the semiconductor chip via the at least one bonding pad.

15. The capacitive sensor of claim 1, further comprising:
a plurality of bonding pads on the semiconductor chip and connected to the sensor electrodes, each of the sensor electrodes including,
a body portion extending in a vertical direction from the top surface of the semiconductor chip, and
a head portion extending in a direction parallel to the top surface of the semiconductor chip at a top surface of the body portion and having a maximum planar area wider than a planar area of the body portion,
wherein an area of each of the bonding pad is comparable to or slightly greater than a planar area of the body portion and substantially smaller than the maximum planar area of the head portion.

16. A capacitive sensor, comprising:
a substrate;
a semiconductor chip on the substrate;
at least one bonding wire electrically connecting the semiconductor chip to the substrate;
a plurality of sensor electrodes on a top surface of the semiconductor chip, and
a mold layer filling a space between the sensor electrodes, at least one of heights of the sensor electrodes and a height of the mold layer being greater than a height of the at least one bonding wire with respect to the top surface of the semiconductor chip by a margin.

17. The capacitive sensor of claim 16, wherein the height of the mold layer is substantially equal to the heights of the sensor electrodes such that a top surface of the mold layer is substantially coplanar with top surfaces of the sensor electrodes.

18. The capacitive sensor of claim 16, wherein the height of the mold layer is greater than the heights of the sensor electrodes such that a top surface of the mold layer is at a higher level than top surfaces of the sensor electrodes.

19. The capacitive sensor of claim 16, each of the sensor electrodes have a T-shaped vertical cross section, which includes,
a body portion extending in a vertical direction from the top surface of the semiconductor chip, and
a head portion extending in a direction parallel to the top surface of the semiconductor chip at a top surface of the body portion, a maximum horizontal cross sectional area of the head portion being substantially greater than a horizontal cross sectional area of the body portion.

20. The capacitive sensor of claim 19, wherein a top surface of the head portion included in each of the sensor electrodes is substantially coplanar with a top surface of the mold layer.

21.-26. (canceled)
